(19) United States
(12) Patent Application Publication
(10) Pub. No.: US 2010/0192106 A1
(43) Pub. Date: Jul. 29, 2010

(54) DISPLAY APPARATUS AND DISPLAY METHOD

(76) Inventors: Shuichi Watanabe, Osaka (JP); Hiroyuki Okada, Osaka (JP)

Correspondence Address: BIRCH STEWART KOLASCH & BIRCH, PO BOX 747, FALLS CHURCH, VA, 22040-0747, US

(21) Appl. No.: 12/667,010

(22) PCT Filed: Jun. 12, 2008
(86) PCT No.: PCT/JP2008/060756

§ 371 Date: Dec. 28, 2009

(30) Foreign Application Priority Data
Jun. 28, 2007 (JP) 2007-170525

(51) Int. Cl. G06F 3/048; H04N 5/91

(52) U.S. Cl. 715/838; 386/68

(57) ABSTRACT

A holding unit 24 generates and holds viewing history information corresponding to the video image from the information on the reproduced video image and the information on the reproduced time of the video image received from a video image display control unit 22. When receiving information of a video image to be displayed by a thumbnail from a thumbnail display control unit 21, a determination unit 25 receives viewing history information of a corresponding video image from the holding unit 24, and determines whether to display a corresponding thumbnail by a moving image or by a still image. A selection unit 26 selects, based on an instruction from the determination unit 25, which of still image data or moving image data is used as video image data to be displayed by the thumbnail for each thumbnail to be displayed by a list on a screen, and outputs the selected one to the thumbnail display control unit 21.

In this way, when the thumbnail is displayed by a list, a plurality of thumbnails are able to be displayed by a moving image in a form that is appropriate for a viewing situation of a user.

### FIELD OF THE INVENTION

The present invention relates to a thumbnail list display to be performed for a video image management, and more particularly, to a display apparatus and a display method for displaying a moving image by a thumbnail in a form that is appropriate for a viewing situation of a user when displaying a moving image by a thumbnail.

### DESCRIPTION OF THE RELATED ART

In reproduction devices (players) and recording and reproduction devices (recorders) of video images, PCs, or the like having a function of recording/reproduction of a video image obtained via broadcasting or a network, a thumbnail display is frequently used as a means to effectively present/manage a number of video images recorded in a recording medium such as a DVD (Digital Versatile Disc), a BD (Blu-ray Disc), an SD memory card, or an HDD (Hard-Disk Drive).

A thumbnail indicates a small image (usually a reduced image of an original image), representing a video image that is displayed instead of a video image, and a thumbnail display indicates a list display form composed of thumbnails of a plurality of video images (representative reduced images). The thumbnail is usually a still image, however, a so-called moving image thumbnail in which a thumbnail is displayed not by a still image but by a moving image is also being spread gradually in accordance with the improvement of processing capability of devices. In a case where the processing capability is sufficient, it is in principle possible to display all the thumbnails by moving images.

FIG. 27 is a functional block diagram showing a schematic configuration of a conventional display apparatus that displays by a list of either still image thumbnails or moving image thumbnails. In a display apparatus 100, still image or moving image thumbnails, arranged by a thumbnail display control unit 101, are displayed by a list on a screen of a display unit 103. The thumbnail display control unit 101, receiving a user's selection operation, sends information of a video image corresponding to a selected thumbnail to a video image display control unit 102. The video image display control unit 102, in accordance with the video image information sent from the thumbnail display control unit 101 and a reproduction operation of the user, reproduces a video image corresponding to the selected thumbnail, to be displayed on a screen of the display unit 103.

As a conventional example of switching a thumbnail by a still image display or a moving image display, Patent Document 1 shows an example in which a thumbnail touched by a cursor is displayed as a moving image, and an example in which only a thumbnail touched by a cursor is displayed as a moving image with a variable frame rate.

FIG. 28 is, according to Patent Document 1, a functional block diagram showing a schematic configuration of a conventional display apparatus that switches between a still image thumbnail and a moving image thumbnail. In a display apparatus 200, still image or moving image thumbnails, arranged by a thumbnail display control unit 201, are displayed by a list on a screen of a display unit 203. The thumbnail display control unit 201, receiving a user's selection operation, sends information of a video image corresponding to a selected thumbnail to a video image display control unit 202. The video image display control unit 202, in accordance with the video image information sent from the thumbnail display control unit 201 and a reproduction operation of the user, reproduces a video image corresponding to the selected thumbnail, to be displayed on a screen of the display unit 203. Furthermore, the thumbnail display control unit 201 notifies a selection unit 204 of information on the user's selection operation, and according to the notification, the selection unit 204 switches whether to send still image thumbnail data or moving image thumbnail data.

### Patent Document 1: Japanese Patent Application Laid-open No. 2004-032535.

### SUMMARY OF THE INVENTION

### Problems to be Solved by the Invention

A thumbnail display is used when a desired video image is selected from video images displayed by a list. In the display apparatus (display apparatus 200 in FIG. 28) of Patent Document 1, a user puts a cursor on a thumbnail one by one so that a thumbnail is switched from a still image display to a moving image display to be reproduced. That is, the switching was not made without the user's cursor operation. In such a case where there is no switching (display apparatus 100 in FIG. 27), all thumbnails are merely displayed either by still images or moving images.

At the time of thumbnail list display, thumbnails of video images that have already been viewed and thumbnails of unviewed video images are displayed in mixture. At this time, since displayed information amount is extremely great, a moving image thumbnail display is effective to efficiently search a video image such as the unviewed video image about which a user in advance has no information (knowledge). On the other hand, with regards to the video image that has already been viewed, and the video image that has already been viewed a number of times, there are demerits such that information is redundant for a user as the viewed (known) video images are repeated in the moving image thumbnail display, and further, quick confirmation of the video image, whether a desired one or not, is disturbed since a display content is continuously changed as the time goes by.

Therefore, in the conventional thumbnail display which equally displays either by a still image or a moving image regardless of an unviewed video image or an already viewed video image, there are problems as follows:

(1) a moving image thumbnail display is appropriate for searching an unviewed video image, however, for a viewed video image, a video image that has already been viewed is to be seen repeatedly, so that information is redundant, and
(2) a still image thumbnail display is appropriate for a viewed video image, however, for an unviewed video image, sufficient information is not able to be obtained so that searching is not able to be performed sufficiently.

Furthermore, in the former, there is also a problem that a high processing load is imposed on a reproduction device by displaying all the thumbnails by moving images all the time.

The present invention has been conceived in view of the above problems, it is therefore to provide a display apparatus and a display method that are capable of displaying a moving image/still image thumbnail in a form that is appropriate for a viewing situation of a user, and making it easier for a user to confirm each video image content and to search a video image efficiently.

### Means to Solve the Problems

According to the present invention, a display apparatus capable of displaying a plurality of video images, accumulated or transmitted, in a form of a list display, includes: holding means for holding viewing history information of the video image; determination means for setting a display form of which an information amount is reduced, for the video image that is able to be determined as a viewer's memory is more certain, based on the viewing history information; and display controlling means for controlling the display form of the video image at the time of list display based on the setting by the determination means.

Here, the display apparatus is characterized in that the viewing history information is information showing an unviewed/viewed state, and the determination means sets a moving image display for the unviewed video image and sets a still image display for the viewed video image.

Additionally, the display apparatus is characterized in that the viewing history information is information showing an elapsed time from a last viewing, and the determination means sets a still image display when the elapsed time is shorter than a predetermined time, and sets a moving image display when the elapsed time is equivalent to or more than a predetermined time.

Further, the display apparatus is characterized in that the viewing history information is information showing the number of viewing times, and the determination means sets a moving image display when the number of viewing times is smaller than a predetermined value, and sets a still image display when the number of viewing times is equivalent to or more than a predetermined value.

Further the display apparatus is characterized in that the viewing history information is information showing the number of viewing times and an elapsed time from a last viewing, and the determination means sets a still image display when the elapsed time is shorter than a first set value, and sets a moving image display when the elapsed time is equivalent to or more than a first set value, in a case where the number of viewing times is smaller than a set value, and sets a still image display when the elapsed time is shorter than a second set value, and sets a moving image display when the elapsed time is equivalent to or more than a second set value, in a case where the number of viewing times is equivalent to or more than a set value.

Further the determination means may set a frame rate at the time of moving image display, may set a digest reproduction of the video image at the time of moving image display, and may set a display size at the time of moving image display.

At this time, in a case where the viewing history information is information showing the number of viewing times, the determination means sets information amount of the video image to be displayed by the moving image to be reduced as the number of viewing times is greater.

And in a case where the viewing history information is information showing an elapsed time from a last viewing, the determination means sets information amount of the video image to be displayed by the moving image to be reduced as the elapsed time is shorter, to be the maximum when unviewed, and sets information amount of the video image to be displayed by the moving image to be increased as the elapsed time is greater.

Further, the display apparatus is characterized in that the holding means holds setting information after a viewer sets a display form at the time of displaying a list of the video image next time, and the determination means sets the display form by obtaining the setting information from the holding means when displaying the video image by a list next time.

And according to the present invention, a display method capable of displaying a plurality of video images, accumulated or transmitted, in a form of a list display, includes: a step of reading out viewing history information of the video image that has been held in holding means; a step of setting a display form of which information amount is reduced for a video image that is able to be determined as remaining in a viewer's memory based on the viewing history information read out by a determination means; and a step of controlling the display form of the video image at the time of list display based on the setting.

### EFFECT OF THE INVENTION

Since a moving image thumbnail includes a large amount of information, it is useful for searching for a user who has not viewed and has no knowledge about a video image or a user who has already viewed, for whom time has elapsed from viewing, however, concerning a video image that has recently been viewed or a video image that has repeatedly been viewed, a user has already obtained enough knowledge, so that information in detail is unnecessary, and the presentation of redundant information disturbs the searching. In the present invention, by setting a display form of which an information amount is reduced, for a video image that is able to be determined as remaining in a viewer's memory, it is possible to avoid a superfluous display of information, as well as to enable the viewer to comfortably search without providing redundant information.

Especially, a viewing history (unviewed or already viewed, the number of times viewed, or a previous viewing time (an elapsed time from a previous viewing)) is held. On the basis of the viewing history held, a display form (a moving image/a still image, or a moving image having a different roughness of a moving image display/roughness of a digest) of a thumbnail is decided. By switching the display form of a thumbnail depending on the user's viewing history, at the time of thumbnail display, a thumbnail that has an appropriate information amount for each video image is displayed, thereby allowing a user to more comfortably search a video image. Additionally, switching a still image/a moving image makes it possible to inform a user instinctively of which video image has not been viewed yet and which video image has already been viewed.

Further, in the present invention, when viewing has been finished, a user is led to select a frame to be displayed by a still image thumbnail next time, or to select the roughness of a moving image thumbnail to be displayed next time, and the selected information is held as a part of a viewing history. Thus a user is able to select an appropriate thumbnail display form on his or her own, thereby allowing the user to more comfortably search a video image.

### BRIEF DESCRIPTION OF THE DRAWINGS

FIG. 1 is a view showing unviewed still image/moving image thumbnails;

FIG. 2 is a view showing viewed still image/moving image thumbnails;

FIG. 3 is a functional block diagram showing a schematic configuration of a display apparatus according to the first embodiment;

FIG. 4 is a view showing an example of viewing history information including video image information, a number of viewing times of the video image, and last viewing time;

FIG. 5 is a view showing an example of viewing history information including video image information, viewed/unviewed information and last viewing time;

FIG. 6 is a view showing an example of viewing history information consisting of video image information and a number of viewing times;

FIG. 7 is a view showing an example of viewing history information consisting of video image information and viewed/unviewed information;

FIG. 8 is a view showing an example of viewing history information including video image information and last viewing time;

FIG. 9 is a flowchart of processing procedures for determining a moving image/still image thumbnail display based on viewed/unviewed information and an elapsed time since viewing;

FIG. 10 is a view showing an example of a thumbnail display by the processing of FIG. 9;

FIG. 11 is a flowchart of processing procedures for determining a moving image/still image thumbnail display based on whether viewed or unviewed;

FIG. 12 is a view showing an example of a thumbnail display by the processing of FIG. 11;

FIG. 13 is a flowchart of processing procedures for determining a moving image/still image thumbnail display based on the number of viewing times;

FIG. 14 is a view showing an example of a thumbnail display by the processing of FIG. 14;

FIG. 15 is a flowchart of processing procedures for determining a moving image/still image thumbnail display based on the number of viewing times and an elapsed time since viewing;

FIG. 16 is an explanatory view showing an example of changing a display size of a moving image thumbnail based on whether unviewed or viewed;

FIG. 17 is an explanatory view showing a display example of changing a frame rate and a digest of a moving image thumbnail based on whether unviewed or viewed;

FIG. 18 is a functional block diagram showing a schematic configuration of a display apparatus according to a second embodiment;

FIG. 19 is a flowchart of processing procedures for shifting a frame rate of a thumbnail step by step based on the number of viewing times;

FIG. 20 is a flowchart of processing procedures for continuously shifting a frame rate;

FIG. 21 is a flowchart of processing procedures for determining a moving image/still image thumbnail display based on an elapsed time from the previous time viewing;

FIG. 22 is a flowchart of processing procedures for shifting a frame rate of a thumbnail step by step based on the number of viewing times;

FIG. 23 is a flowchart of procedures for continuously shifting a frame rate;

FIG. 24 is an explanatory view of a selection screen displayed after finishing viewing in a fourth embodiment;

FIG. 25 is another explanatory view of a selection screen displayed after finishing viewing in the fourth embodiment;

FIG. 26 is still another explanatory view of a selection screen after finishing viewing in the fourth embodiment;

FIG. 27 is a functional block diagram showing a schematic configuration of a conventional display apparatus displaying a list of either still image thumbnails or moving image thumbnails;

FIG. 28 is a functional block diagram showing a schematic configuration of a conventional display apparatus that switches a still image thumbnail and a moving image thumbnail.

### EXPLANATIONS OF NUMERALS

10 screen
11 still image thumbnail
12, 13, 14, 15, 16 moving image thumbnail screen
20 display apparatus
21 thumbnail display control unit
22 video image display control unit
23 display unit
24 holding unit
25 determination unit
26 selection unit
31, 32, 33, 34, 35 viewing history information
41, 42, 43 screen
50, 55 screen
51, 52, 53, 56, 57, 58 moving image thumbnail
60 display apparatus
65 determination unit
70 screen
61 thumbnail display control unit
71 description
72 moving image thumbnail switch
73 still image thumbnail switch
74 moving image thumbnail
75 still image thumbnail

### DESCRIPTION OF PREFERRED EMBODIMENTS

Hereinafter, embodiments of the present invention will be described with reference to accompanying drawings.

A display apparatus of the present invention, for example, in an AV player (reproduction apparatus) or an AV recorder (recording/reproduction apparatus) that is capable of displaying a thumbnail by a still image and a moving image, switches to a moving image thumbnail display for an unviewed video image and to a still image thumbnail display for an already viewed video image. Alternatively, a display level (roughness of information) of the moving image thumbnail is switched step by step based on a viewing history (the number of times). It is also possible to switch based on an elapsed time from previous viewing. A video image displayed by the thumbnail is provided for any of accumulated video images accumulated in an HDD and a flash memory inside an apparatus such as a player and a recorder, recorded video images and transmitted video images that are obtained via a recording medium such as a DVD, a BD, and an SD memory card, or via a broadcast and a network.

A moving thumbnail has a large amount of information and is useful for searching for a user who has not viewed and has no knowledge about a video image or for a user who has viewed the video image long time ago and for whom a long time has elapsed since the last viewing. However, since the user already has enough knowledge about the video image recently viewed or the video image repeatedly viewed, detailed information is unnecessary, and the presentation of excessive amount of information disturbs searching. In some cases, a still image thumbnail is rather appropriate for the user.

Therefore, the thumbnail which is determinable by the user's viewing within user's recollection is provided in a thumbnail display form having a small amount of information, and the one unviewed or the one that a long time has elapsed from the last viewing is provided in a thumbnail display form having a large amount of information. In this way, it is possible to perform a moving image/still image thumbnail display in a form that is appropriate for a viewing situation of a user.

Hereinafter, each embodiment will be specifically described.

### First Embodiment

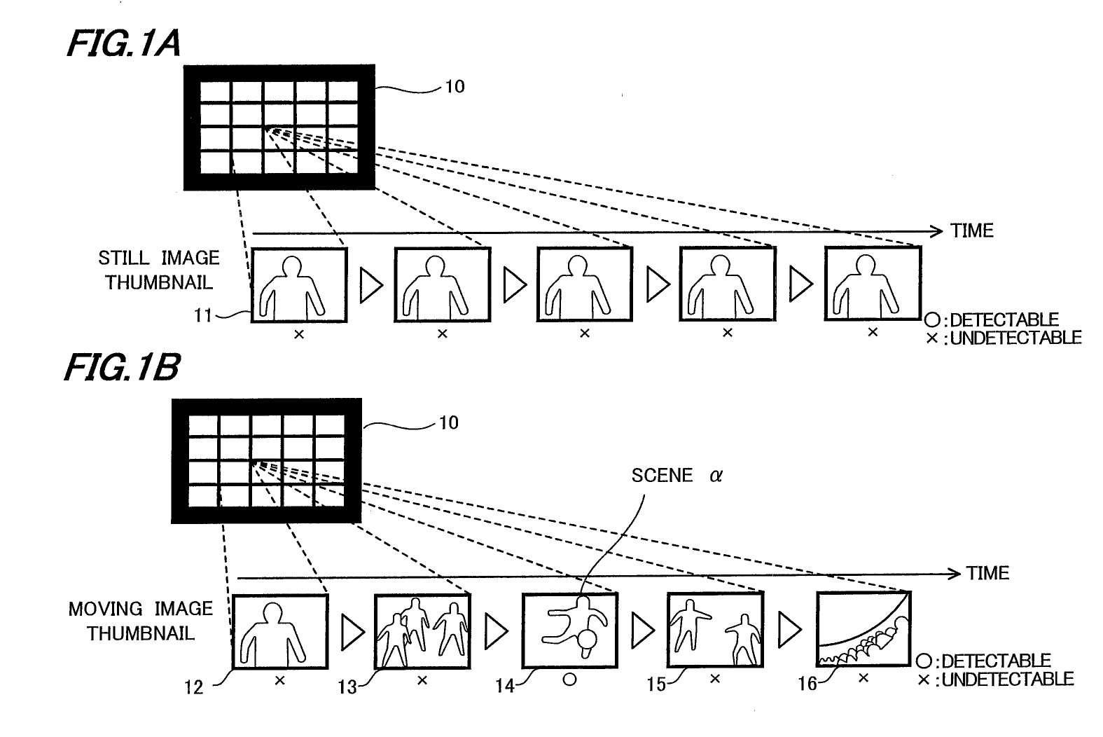

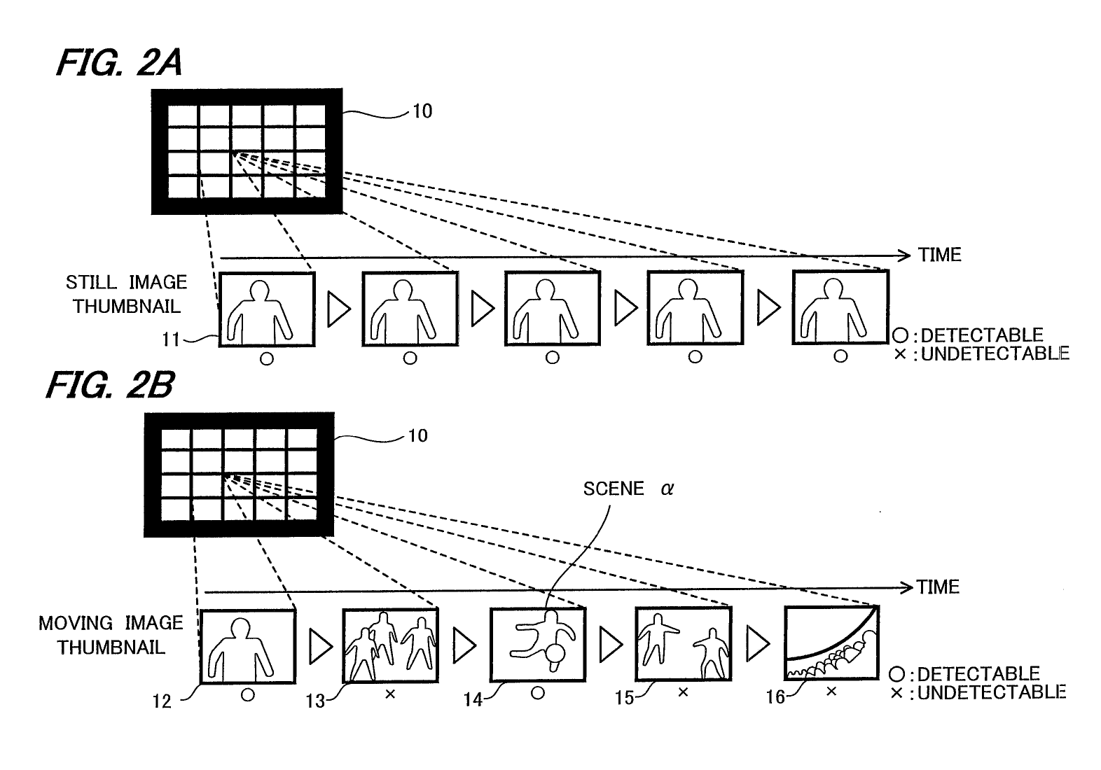

A concept of a first embodiment will be described. FIG. 1 shows unviewed still image/moving image thumbnails. FIG. 2 shows viewed still image/moving image thumbnails.

A still image thumbnail 11 or moving image thumbnails 12 to 16 are displayed on a screen 10 of FIGS. 1 and 2. As shown in FIGS. 1A and 2A, the still image thumbnail 11 is the same image as the first thumbnail 12 of the moving image thumbnails, and the same images are displayed even when time elapses. On the other hand, video images in the moving image thumbnail are changed with the passage of the time, as shown in FIGS. 1B and 2B, different images are displayed with the passage of the time. The moving image thumbnails 12 to 16 show images displayed every specific time.

FIG. 1 shows a case where a user has not yet viewed a video image, and a scene a (scene of the moving image thumbnail screen 14) is a scene which the user desires to see. Not having viewed yet, the user does not know in which video image the scene a is included. At this time, since the video images do not move in the still image thumbnail 11, the user is unable to confirm whether or not the scene a is included in the video image by looking at the thumbnail (see FIG. 1A). On the other hand, in the moving image thumbnail, the moving image thumbnail 14 as the scene a is displayed, which makes it possible to confirm that the scene a is included (see FIG. 1B).

However, when having viewed the video image and already known that the scene a is included in the video image of the still image thumbnail 11, the user knows that the target scene a is included in the video image only by looking at the still image thumbnail 11 of FIG. 2A (see FIG. 2A). Meanwhile, in the case of moving image thumbnails 12 to 16 of FIG. 2B, it is rather difficult for the user to confirm that the target scene a is included in the video image during a period when the first thumbnail screen 12 (still image thumbnail 11 that represents the video image) and other screens than the thumbnail screen 14 are displayed (see FIG. 2B).

Accordingly, in the first embodiment, viewing history information showing a viewed state or an unviewed state is held. On the basis of the information, a moving image thumbnail is displayed when unviewed, and when viewed, a still image thumbnail is selected to be switched and displayed.

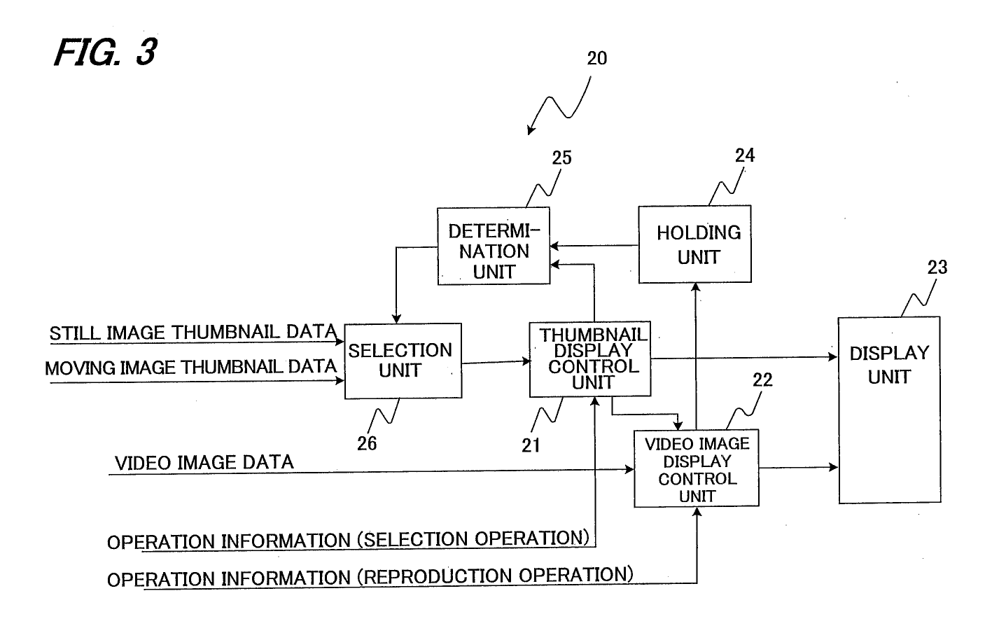

FIG. 3 is a functional block diagram showing a schematic configuration of a display apparatus according to the first embodiment. A display apparatus 20 is configured to include a thumbnail display control unit 21, a video image display control unit 22, a display unit 23, a holding unit 24, a determination unit 25, and a selection unit 26.

The thumbnail display control unit 21 controls the reproduction of each of thumbnail data (including a decoding process for encoded data) displayed on a screen of the display unit 23, and arrangement of the thumbnail onto the screen. The thumbnail data is either moving image thumbnail data or still image thumbnail data, which is selected by the selection unit 26 described below.

The thumbnail display control unit 21 receives operation information (selection operation) from the user and, when the thumbnail is selected, notifies the video image display control unit 22 of the information on the corresponding video image.

The video image display control unit 22 receives the video image information received from (selected by) the thumbnail display control unit 21 and the corresponding video image data, and controls the reproduction of the video image data (including a decoding process for encoded data) in accordance with the operation information (reproduction operation) from the user. The reproduced video image is displayed on the screen of the display unit 23. At this time, the video image display control unit 22 sends information on the reproduced (viewed) video image and reproduced time information on reproduced time of the video image to the holding unit 24.

The holding unit 24 generates and holds viewing history information corresponding to the video image from the information on the reproduced video image and the information on the reproduced time of the video image received from the video image display control unit 22.

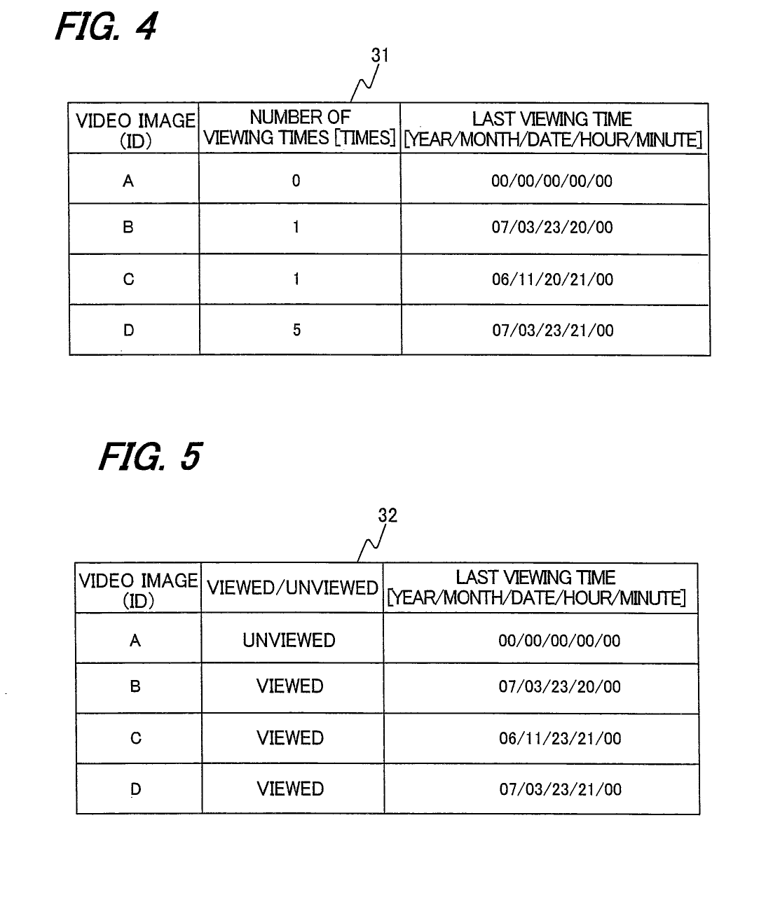

FIGS. 4 to 8 show examples of the viewing history information generated and held by the holding unit 24.

Viewing history information 31 shown in FIG. 4 is an example of viewing history information including video image information (ID), a number of viewing times (“times”) of the video image, and last viewing time (“year/month/date/hour/minute”). A form of the last viewing time is not limited thereto, but any time expression generally used is usable. For example, a total number of seconds from a time as a starting point, a total number of clocks, and the like may be used. Note that, in the present embodiment, ID information is used as information indicating the video image to uniquely specify the video image, but not particularly limited to the ID information, any information capable of uniquely specifying the video image may be used. For example, as long as the video image is uniquely specified, title information or the like may be used. Furthermore, the number of viewing times of the video image may be counted at a time when the video image is reproduced, or may be counted after the whole video image is viewed. Alternatively, counting may be performed at a time when a certain amount of video images is reproduced (viewed). This is realized by setting a certain length of time for a reference and starting to count at a time when a reproduction time exceeds that length of time. Whether to register as a last viewing time can be similarly applied.

Viewing history information 32 shown in FIG. 5 is an example of holding information showing whether viewed or unviewed (unviewed/viewed) in place of the number of viewing times (times) in the example of the viewing history information 31.

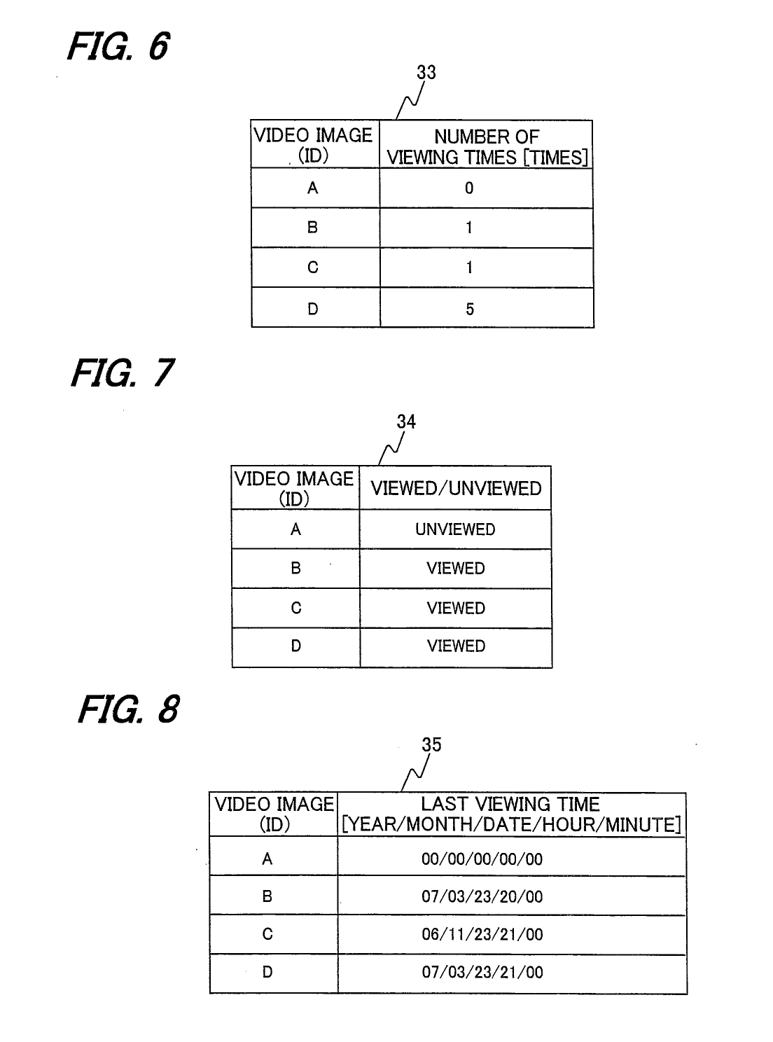

Viewing history information 33 shown in FIG. 6 is an example of consisting of video image information (ID) and the number of viewing times (times). The viewing history information 34 shown in FIG. 7 is an example of consisting of the video image information (ID) and the viewed/unviewed information (unviewed/viewed). Viewing history information 35 shown in FIG. 8 is an example of including the video image information (ID) and the last viewing time

(“year/month/date/hour/minute”).

Note that, when the number of viewing times is “0”, the video image is unviewed. That is, the viewed/unviewed information is represented by the information of the number of viewing times. Furthermore, assuming that, when the last viewing time is an initial value “00/00/00/00/00”, the video image is unviewed, the viewed/unviewed information is represented by the last viewing time information. In this manner, it is possible to select and hold necessary viewing history information.

Accordingly, when the initial value of the last viewing time is a time that is a starting point for measuring the time and the last viewing time to be registered in viewing is always a time following the initial value, the elapsed time of an unviewed time (=a current time−the initial value of the last viewing time) is computationally provided as a maximum possible value of elapsed time values. In the example above, since the initial value is “00/00/00/00/00”, the elapsed time of the unviewed time=a time corresponding to the current time (the maximum value). (The initial value of 0 month 0 date is a logically impossible value, but is used here for the sake of convenience to exemplify the time corresponding to the current time equivalent to the maximum value.)

The thumbnail display control unit 21 also sends information on the video image to be displayed by the thumbnail to the determination unit 25.

When receiving the information on the video image to be displayed by the thumbnail from the thumbnail display control unit 21, the determination unit 25 receives the viewing history information of the corresponding video image from the holding unit 24 and determines, according to the received viewing history information, whether to display the thumbnail corresponding to the video image by a moving image or a still image.

The selection unit 26 selects, based on an instruction from the determination unit 25, either still image data or moving image data as the video image data to be displayed by the thumbnail, for each thumbnail displayed by a list on the screen, and outputs the selected one to the thumbnail display control unit 21.

Next, description will be given in detail for an operation that the display apparatus 20 switches a thumbnail display in accordance with the viewing history information.

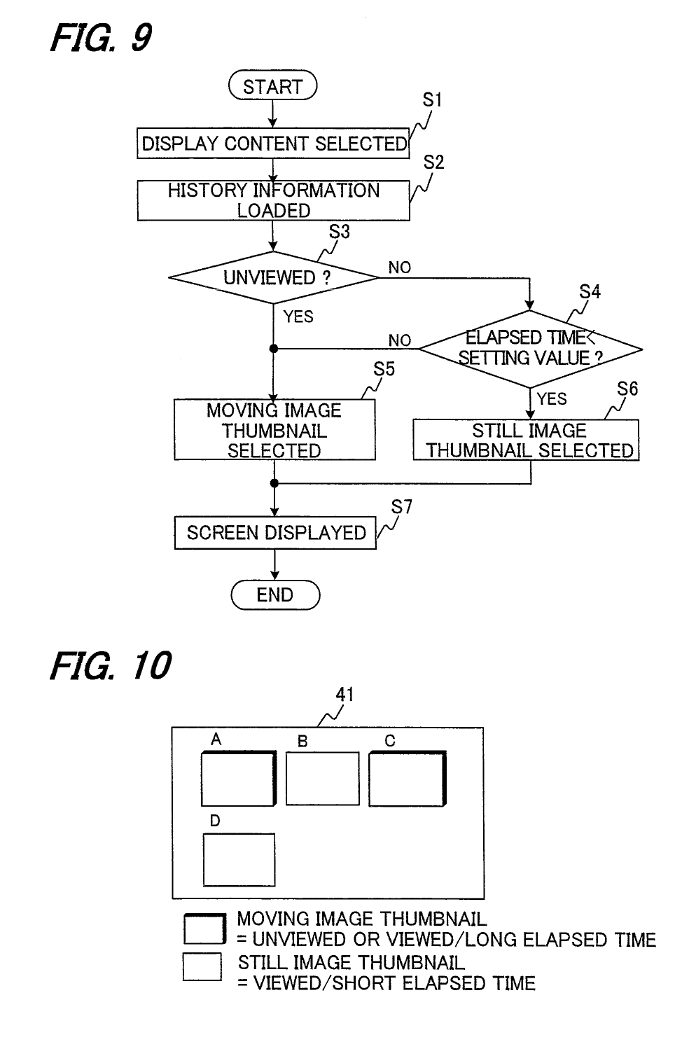

FIG. 9 is a flowchart of processing procedures for determining a moving image/still image thumbnail display based on whether viewed or unviewed and an elapsed time from viewing.

When the thumbnail display control unit 21 displays the thumbnail on the display unit 23 by receiving the thumbnail data, the thumbnail display control unit 21 first selects the video image (content) to be displayed by the thumbnail and sends the information to the determination unit 25 (step S1). The determination unit 25 loads history information corresponding to the selected video image from the holding unit 24 (step S2).

Here, the viewing history information is the viewing history information 31 of FIG. 4 or the viewing history information 32 of FIG. 5. The video images A, B, C, and D are to be displayed by the thumbnails. The current time is at 17:00 on Mar. 26, 2007 (“07/03/26/17/00”). At the time, the determination unit 25 determines from the viewing history information 31 whether the thumbnail video images A, B, C and D are viewed or unviewed.

The determination unit 25 determines from the obtained history information whether the video image is unviewed or viewed (step S3). In the viewing history information 31 of FIG. 4, since the number of viewing times is “0”, the video image A is unviewed. Video images B, C, and D are viewed since the number of viewing times are “1”, “1”, and “5”, respectively. Furthermore, in the case where the viewing history information 32 of FIG. 5 is applied, it is only necessary to use data showing an unviewed/viewed state.

When unviewed (step S3; Yes), the moving image thumbnail is selected (step S5). When viewed (step S3; No), the procedure goes to determination of the elapsed time (step S4).

At the step S4, the determination unit 25 determines based on the history information whether the elapsed time from the last viewing of the viewed video image is smaller than a set value (time) given in advance. When the elapsed time is smaller than the set value because sufficient time has not elapsed from the last viewing (step S4; Yes), the still image thumbnail is selected (step S6). When the elapsed time is equivalent to or more than the set value because sufficient time has elapsed from the last viewing (step S4; No), the moving image thumbnail is selected (step S5).

For example, the elapsed time from the last viewing of the viewed video images B, C and D is calculated based on a difference between the last viewing time held in the viewing history information 31 or the viewing history information 32 and the current time. The elapsed time of the video image B is; “07/03/26/17/00”−“07/03/23/20/00”=“00/00/02/21/00” (2 days and 21 hours). Similarly, the elapsed time of the video image C is; “07/03/26/17/00”−“06/11/23/21/00”=“00/04/02/20/00” (4 months, 2 days and 20 hours), and the elapsed time of the video image D is “07/03/26/17/00”-“07/03/23/21/00”=“00/00/02/20/00” (2 days and 20 hours).

Even the video image had been viewed, for the one that sufficient time has elapsed from a last viewing, a user's memory is considered to be fading. Here, assuming that the setting value is three months, the elapsed time of the video image that has been viewed more than three months later is set as “long”, or the elapsed time of the video image that has been viewed less than three months later is set as “short”. As a result, the determination unit 25 decides to display the unviewed video image A and the viewed video image C, whose elapsed time is determined as long, with the moving image thumbnail and decides to display the other video images B and D with the still image thumbnail.

The selection unit 26 selects, in the case of the step S5, the moving image thumbnail data to send to the thumbnail display control unit 21, and selects, in the case of the step S6, the still image thumbnail data to send to the thumbnail display control unit 21. The thumbnail display control unit 21 reproduces, arranges and displays the input moving image thumbnail data and the still image thumbnail data (step S7). FIG. 10 shows a screen 41 where the video images A, B, C, and D are displayed by the thumbnail. The video images A and C are the moving image thumbnails and the video images B and D are the still image thumbnails.

FIG. 11 is a flowchart of processing procedures for determining a moving image/still image thumbnail display based on whether viewed or unviewed. The same processing steps as FIG. 9 are denoted by the same numerals and detailed description will be omitted.

At step S2, the determination unit 25 loads the viewing history information. Here, the viewing history information 34 of FIG. 7 is loaded. The determination unit 25 determines based on the obtained viewing history information 34 whether the video image is unviewed or viewed (step S3). The video image A alone is unviewed and the video images B, C, and D are viewed. When the video image is unviewed (step S3; Yes), the moving image thumbnail is selected (step S5). When viewed (step S3; No), the still image thumbnail is selected (step S6).

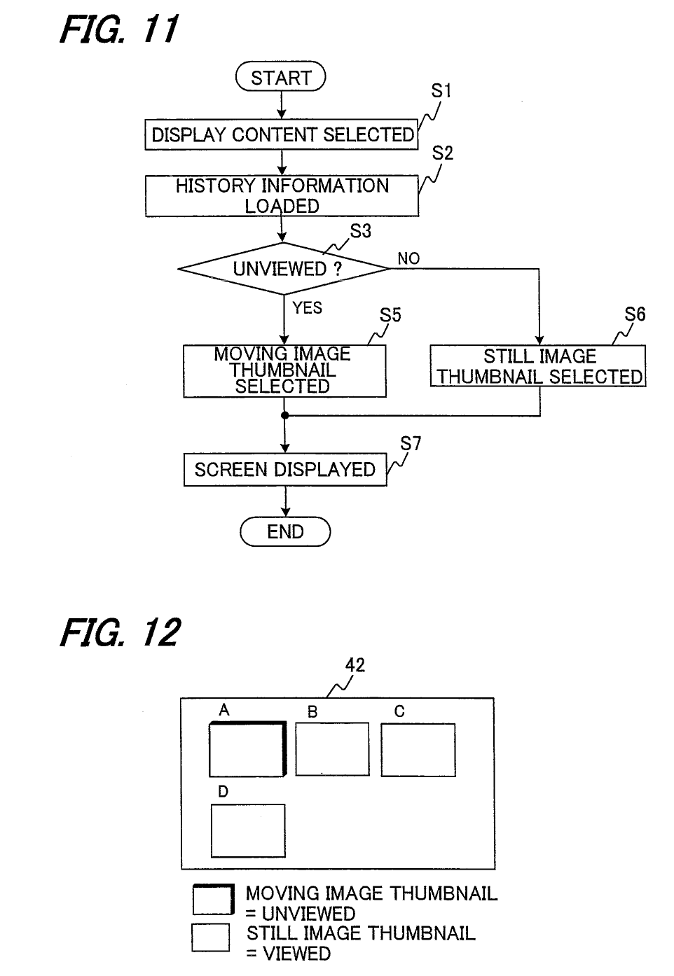

Accordingly, as shown in a screen 42 of FIG. 12, the video image A alone is the moving image thumbnail and the video images B, C, and D are the still image thumbnail.

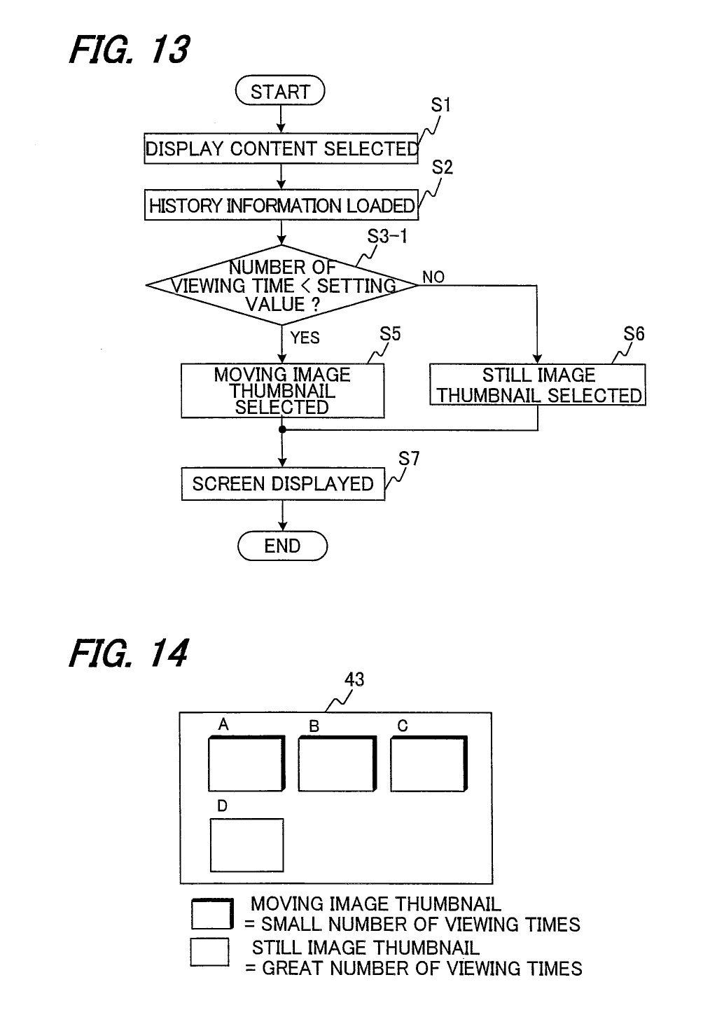

FIG. 13 is a flowchart of processing procedures for determining a moving image/still image thumbnail display based on the number of viewing times. The same processing steps as FIG. 9 are denoted by the same numerals, and detailed description will be omitted.

At the step S2, the determination unit 25 loads the viewing history information. Here, the viewing history information 33 of FIG. 6 is loaded. The determination unit 25 determines based on the obtained viewing history information 33 whether the video image is unviewed or viewed (step S3-1). The determination unit 25 determines whether or not the number of viewing times is smaller than a set value (number of times) given in advance.

For example, assuming that the number of viewing time of less than three times is set as unviewed, the viewing times of three or more are defined as viewed. Accordingly, when the number of viewing times is less than the set value, three times (step S3-1; Yes), the moving image thumbnail is selected (step S5). When the number of viewing times is equivalent to or more than the set value, three times (step S3-1; No), the still image thumbnail is selected (step S6).

In the viewing history information 33 of FIG. 6, the number of viewing times of video image A is “0”, the number of viewing times of video images B and C are both “1” and any of video images A, B, and C is less than three times. On the other hand, the number of viewing times of video image D is “5”, which is more than three times. As a result, as shown in a screen 43 of FIG. 14, the video images A, B, and C are the moving image thumbnails, regarded as unviewed, and only the video image D is the still image thumbnail, regarded as viewed.

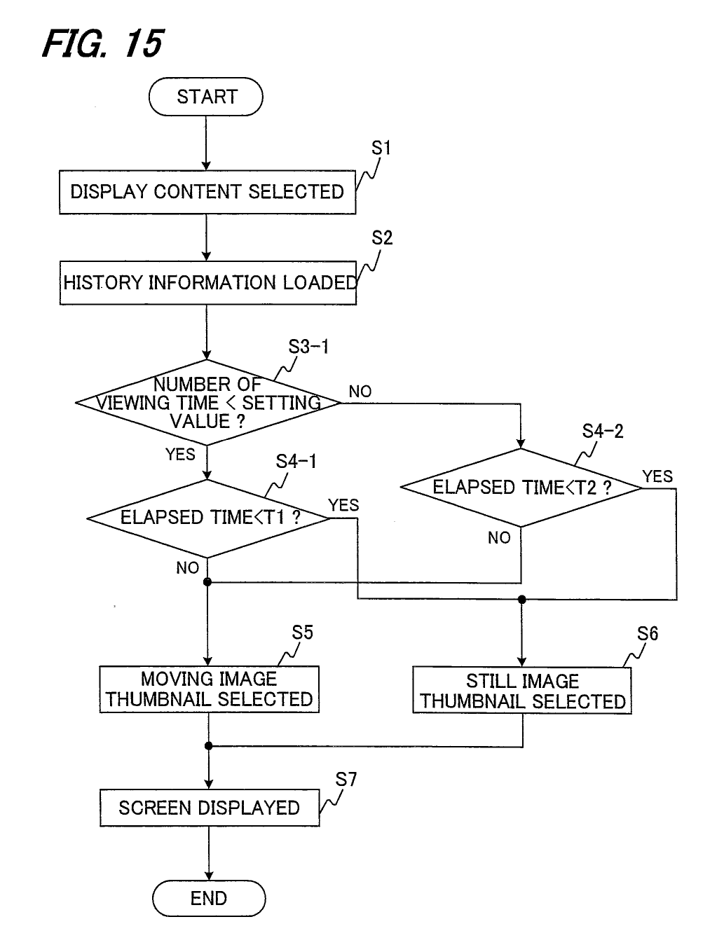

FIG. 15 is a flowchart of processing procedures for determining a moving image/still image thumbnail display based on the number of viewing times and the elapsed time from viewing. In operations of FIG. 15, a step S4-1 and step S4-2 are added to follow a step S3-1 of FIG. 13 and the description will focus on those steps because other operations than those parts are the same.

At the step S2, the determination unit 25 has obtained the viewing history information 31 of FIG. 4 from the holding unit 24. At the step S3-1, the determination unit 25 determines whether the number of viewing times is smaller than a set value (number of times) given in advance. Here, as described in the step S3-1 of FIG. 14, the set value is set to three times. When the number of viewing times is less than the set value (step S3-1; Yes), the procedure goes to the step S4-1. When the number of viewing times is equivalent to or more than the set value (step S3-1; No), the procedures goes to a step S4-2.

Next, two setting values (time) are set for determining the elapsed time, which are referred to as T1 and T2. Assuming that T1 is less than T2 (T1<T2), T1 is 7 days and T2 is 1 month. Here, as explained in the description of step S4 of FIG. 9, the elapsed time of the viewed video images B, C, and D from the last viewing is calculated based on a difference between the last viewing time held in the viewing history information 31 and the current time. The elapsed time of the video image B is; “07/03/26/17/00”−“07/03/23/20/00”=“00/00/02/21/00” (2 days and 21 hours). Similarly, the elapsed time of the video image C is; “07/03/26/17/00”−“06/11/23/21/00”=“00/04/02/20/00” (4 months, 2 days and 20 hours), and the elapsed time of the video image D is “07/03/26/17/00”−“07/03/23/21/00”=“00/00/02/20/00” (2 days and 20 hours). Furthermore, the video image A is unviewed and the initial value “00/00/00/00/00” is registered as the last viewing time Therefore, the elapsed time is; “07/03/26/17/00”-“00/00/00/00/00”=“07/03/26/17/00”, that is, the elapsed time corresponding to the current time is calculated.

When the number of viewing times is not sufficient (less than three times in the present case), the user does not remember the video image well. Accordingly, since the time (period) when the viewed video image remains in the user's memory is supposed to be short, the determination unit 25 determines a thumbnail display on the basis of the set value T1 which is set to 7 days. At the step S4-1, the determination unit 25 determines whether or not the elapsed time is less than T1 (elapsed time<T1), when this is satisfied, that is, the elapsed time is less than 7 days (step S4-1; Yes), it is determined that the user still remembers the content of the video image, and the still image thumbnail display is selected (step S6). The video image B is the case in the viewing history information 31 of FIG. 4.

When the elapsed time is equivalent to or more than T1 (elapsed time>T1), that is, 7 or more days have elapsed from the last viewing (step S4-1; No), the determination unit 25 selects the moving image thumbnail display (step S5) assuming that the video image does not remain in the user's memory. In the viewing history information 31 of FIG. 4, the video image C is applied. Furthermore, as described above, since the elapsed time of the unviewed video image A is calculated as the maximum elapsed time value corresponding to the current time, the video image A also fits in the case where the elapsed time is equivalent to or more than T1 (elapsed time>T1).

When the number of viewing times is sufficient (three times or more in the present example), the user does remember the video image well. Accordingly, since the time (period) when the viewed video image remains in the user's memory is supposed to be long, the determination unit 25 determines the thumbnail display on the basis of the set value T2 which is set to one month. At a step S4-2, when the elapsed time is smaller than the set value T2 (that is, when the elapsed time is less than one month) (step S4-2; Yes), the determination unit 25 selects the still image thumbnail display (step S6) assuming that the user has a memory of the video image. In the viewing history information 31 of FIG. 4, the video image D is applied.

When the elapsed time is equivalent to or more than the set value T2 (that is, the elapsed time is one month or more) (step S4-2; No), the determination unit 25 selects the moving image thumbnail display (step S6) assuming that the user does not remember the video image. In the viewing history information 31 of FIG. 4, any video image is not applied.

As a result, in the above-described operation example with the use of the flowchart of FIG. 15, as shown in the screen 41 of FIG. 10, the video images A and C are the moving image thumbnails and the video images B and D are the still image thumbnails.

Furthermore, in the example of FIG. 15, the process first branches off based on the determination of the number of viewing times, then the process is determined based on the elapsed time. However, in contrast, it may as well be assumed that the process first branches off based on the elapsed time, then the process is determined based on the number of viewing times. In this case, the number of viewing times N1 and N2 (N1<N2) is set. When the elapsed time is short, the determination is performed by the smaller number of viewing times N1 (moving image when the number of viewing times N<N1 and still image when N≧N1), and when the elapsed time is long, the determination is performed by the greater number of viewing times N2 (moving image when the number of viewing times N<N2 and still image when N≧N2). In addition to this, the order relation of the process to be determined based on the viewing history information is not particularly limited.

Note that, the still image data and the moving image data used for the thumbnail display are illustrated as different data from original video image data in FIG. 3, but such still image data and moving image data used for the thumbnail display may as well be any one of either data directly obtained from the original video image data that the thumbnail represents, or data given separately from the original video image data. The present invention does not particularly limit when and how the still image data and the moving image data for the thumbnail display are prepared. For example, it may as well be constructed such that, every time the thumbnail is displayed, a video image device including the display apparatus 20 creates the still image/moving image data for the thumbnail display from the original video image, or such that at a stage when the original video image data is accumulated in the video image device including the display apparatus 20, the still image/moving image data for the thumbnail display is created and used by accumulating separately. Naturally, the original video image data is able to be used as moving image data for the moving image thumbnail display.

In this manner, based on the viewing history information, when remaining in a viewer's memory, the still image thumbnail that a user is able to quickly recognize is displayed. When nothing or little remains in the viewer's memory (or the memory is fading), the moving image thumbnail is displayed. Accordingly, it is possible to avoid a display of redundant information, as well as to allow the viewer to comfortably search without providing unnecessary information.

### Second Embodiment

In the second embodiment, a method for displaying a moving image thumbnail is changed by whether viewed or unviewed, and the difference thereof is known to a user. In contrast to the first embodiment where selection of the still image display or the moving image display is provided, the thumbnail to be displayed is always the moving image display and the method for displaying (reproducing) is able to be selected, but otherwise is basically unchanged.

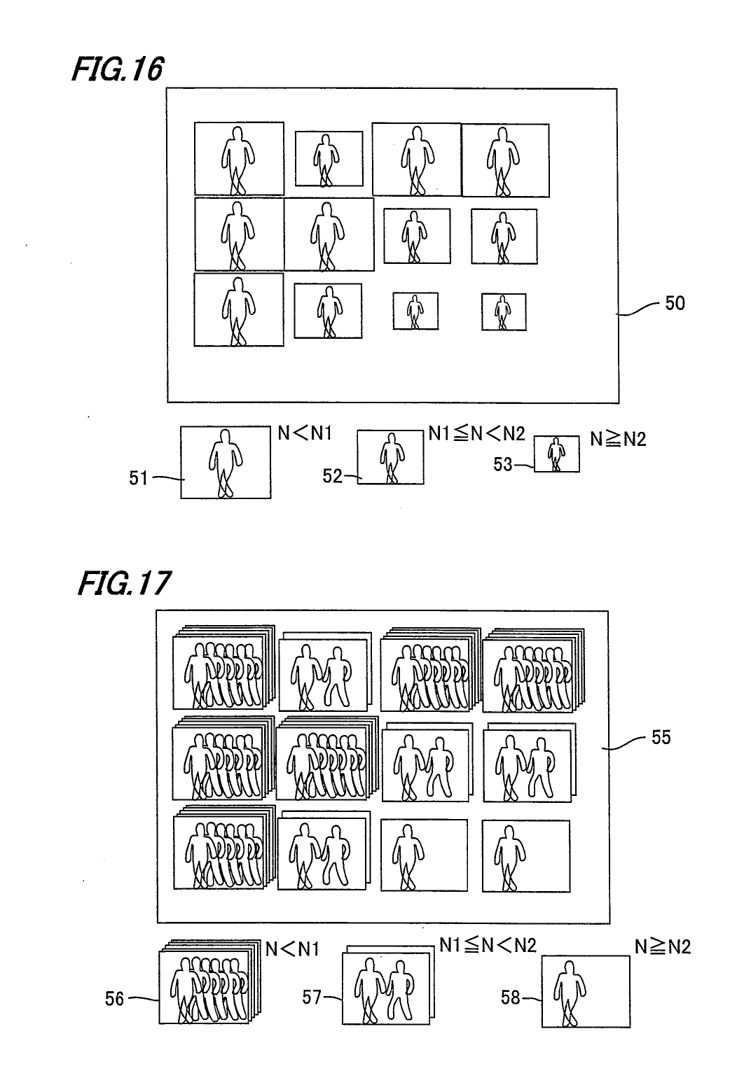

FIG. 16 is an explanatory view showing an example of changing a display size of the moving image thumbnail based on whether unviewed or viewed. A screen 50 displays thumbnails in three kinds of size. The thumbnail size is decided based on the number of viewing times. When the number of viewing times is N and set values are N1 and N2, it is assumed that the set value N1 is less than the set value N2 (N1<N2). When the number of viewing times N is less than the set value N1 (N<N1), a thumbnail 51 of the largest size is displayed. When the number of viewing times N is equal to or more than the set value N1 and less than the set value N2 (N1≦N<N2), a thumbnail 52 of the middle size is displayed. When the number of viewing times N is equal to or more than the set value N2 (N≧N2), a thumbnail 53 of the smallest size is displayed.

In this way, it is recognizable at a glance which thumbnail is unviewed and which thumbnail has been viewed. At the same time, since the moving image thumbnails of the viewed video images are displayed in a tiny and inconspicuous manner, the display of the moving image thumbnails of the unviewed video images is not disturbed.

FIG. 17 is an explanatory view showing a display example, in which a frame rate of the moving image thumbnail is changed, or a type of digest is changed (roughness of a summary is adjusted), based on whether unviewed or viewed. Note that, FIG. 17 schematically shows a changing state of the thumbnail display in a constant time by means of overlaying frames displayed in the constant time and objects (object) displayed in each frame in the constant time on the screen. A thumbnail 56 with a high display frame rate shows that the object is displayed densely in the moving image. A thumbnail 58 with a low display frame rate shows that the object is displayed in a condition close to the still image display. Naturally, a real display is not in a form of overlaying the illustrated objects, but a moving object is displayed on each sheet of the illustrated frames.

A screen 55 displays thumbnails of three kinds of frame rates or digests. The frame rate (or digest) is decided based on the number of viewing times similarly to the example of the above FIG. 16. When the number of viewing times N is less than the set value N1 (N<N1), the thumbnail 56 with the maximum frame rate (or digest with the minimum roughness) is displayed, when the number of viewing times N is equal to or more than the set value N1 or less than the set value N2 (N1≦N<N2), a thumbnail 57 in the middle frame rates (or digest with the middle roughness) is displayed, and when the number of viewing times N is equal to or more than the set value N2 (N N2), the thumbnail 58 with the minimum frame rate (or digest with the maximum roughness) is displayed.

In this way, it is recognizable at a glance which thumbnail is unviewed and which thumbnail is viewed. At the same time, as the display of the viewed one becomes rougher to be inconspicuous, the display of the moving image thumbnail of the unviewed video image is not disturbed.

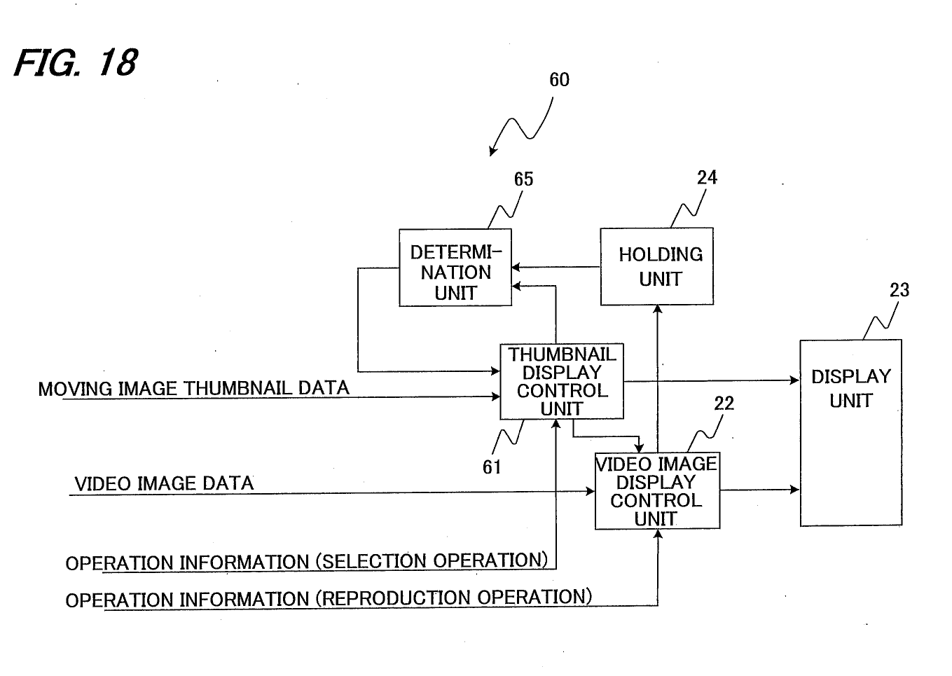

FIG. 18 is a functional block diagram showing a schematic configuration of a display apparatus according to the second embodiment.

A display apparatus 60 is configured to include a thumbnail display control unit 61, a video image display control unit 22, a display unit 23, a holding unit 24, and a determination unit 65. The same parts (video image display control unit 22, display unit 23, holding unit 24) as the display apparatus 20 (see FIG. 3) of the first embodiment are denoted by the same numerals.

Different points between the display apparatus 20 of the first embodiment and the display apparatus 60 of the present embodiment are as follows:

(1) While the moving image and still image thumbnails are input to the thumbnail display control unit 21, moving image thumbnail data alone is input to the thumbnail display control unit 61.
(2) The selection unit 26 is not provided in the present embodiment.
(3) The thumbnail display control unit 21 and the determination unit 25 operate differently, compared with the thumbnail display control unit 61 and the determination unit 65. Particularly, the output of the determination unit 65 is input to the thumbnail display control unit 61 to perform a frame rate conversion, a size conversion or a digest conversion.

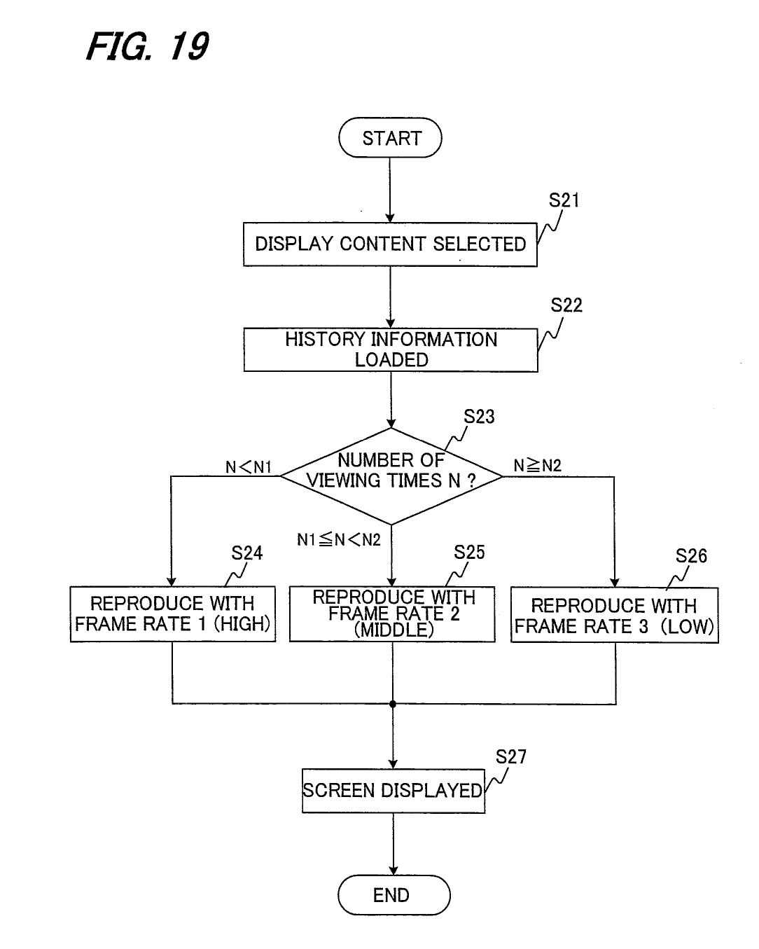

FIG. 19 is a flowchart of processing procedures for shifting a frame rate of the thumbnail step by step based on the number of viewing times.

The thumbnail display control unit 61 sends information of a video image (content) to be displayed by the thumbnail to the determination unit 65 (step S21). The determination unit 65 loads history information corresponding to the selected video image from the holding unit 24 (step S22). The determination unit 65 compares the number of viewing times N with the set values N1, N2 (N1<N2) based on the obtained history information for determination (step S23). When the number of viewing times N is less than the set value N1 (N<N1), the moving image thumbnail with a high frame rate is selected (step S24). When the number of viewing times N is equal to or more than the set value N1 and less than the set value N2 (N1≦N<N2), the moving image thumbnail 57 with a middle frame rate is selected (step S25). When the number of viewing times N is equal to or more than the set value N2 (N<N2), the moving image thumbnail 58 with a low frame rate is selected (step S26).

The thumbnail display control unit 61 reproduces the input moving image thumbnail data at a frame rate set by the determination unit 65, which is arranged and displayed on the screen of the display unit (step S27).

In the flowchart above, the frame rate has been described, but the display size or the roughness of the digest may as well be shifted step by step. For example, the maximum display size or the fine digest is provided at a step S24, the middle display size or the middle digest at a step S25, and the minimum display size or the rough digest at a step S26.

Furthermore, in the example shown in FIG. 19, the display form of the moving image thumbnails to be displayed is shifted in three steps, but not limited to three steps, the display form may as well be shifted by setting multiple steps such as four steps or five steps. Naturally, two steps are applicable.

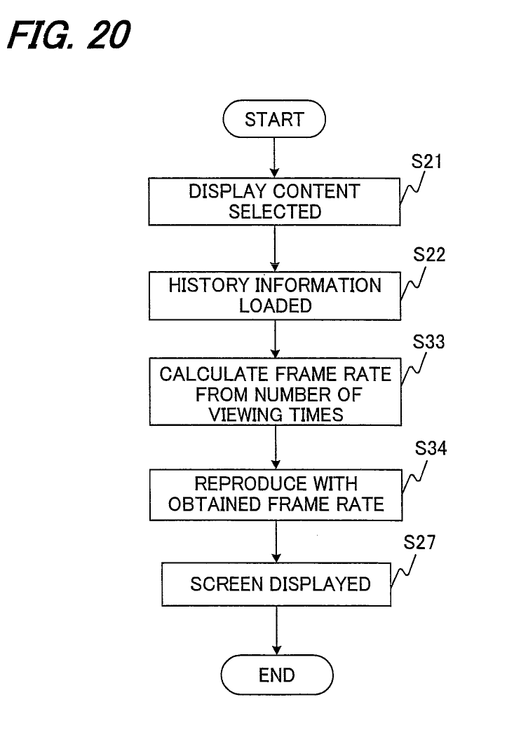

FIG. 20 is a flowchart which shows procedures for continuously shifting the frame rate. Different points from the flowchart of FIG. 19 are the parts of steps S33 and S34. The previous and subsequent processes of the steps are same, so that the same numerals as FIG. 19 are denoted.

At a step S33, the determination unit 65 calculates a frame rate based on the number of viewing times. A calculation formula at this time is given in advance and the calculation is performed using this calculation formula. For example, in view of the number of viewing times N [times] and the frame rate r [frame/second], the calculation formula f(N) is defined as;

r=f(N)=30/(N+1)

30 [frame/second] is produced when the number of viewing times is 0 times, which means for being unviewed. 15 [frame/second] is produced when the number of viewing times is 1 time.

Naturally, the calculation formula for calculating the frame rate is not limited to the above example. Alternatively, a data table capable of obtaining the frame rate based on the number of viewing times may be provided to obtain. If the number of viewing times is greater, it can be determined that the memory is reliably retained. Accordingly, the amount of information of the display form is reduced by the defined calculation formula as the number of viewing times is greater. That is, the frame rate is lowered.

The thumbnail display control unit 61 reproduces the input moving image thumbnail data at a frame rate set by the determination unit 65 (step S34), which is displayed on the screen of the display unit 23 (step S27).

Note that, the frame rate has been described in the flowchart above, but the display size or the roughness of the summary by the digest may be shifted continuously. The display size is reduced, or the digest is set roughly, when the number of viewing times is great.

In this way, if the number of viewing times is greater, it is assumed that the user's memory is retained. The information amount of the thumbnail display form is reduced. Thus, when the thumbnail is displayed, the thumbnail having an appropriate information amount is displayed for each video image, which enables the user to search the video image more comfortably.

Furthermore, it is also possible to apply a modification processing of the method for displaying the moving image thumbnail based on the above-mentioned viewing history to a part of the video image as it is. That is, in the above description, it is determined whether the whole video image is unviewed or viewed. The display size of the moving image thumbnail of the video image, the frame rate or the type of digest (roughness of summary) are changed, but it is also possible to determine whether a part, instead of the whole, of the video image is viewed or unviewed. The display size of the moving image thumbnail of the part, the frame rate or the type of digest (roughness of summary) may be changed. For example, when the viewing of a 30-minute video image is stopped after 10 minutes from the beginning of the viewing, the 10-minute forepart of the video image is viewed from the start and the remaining 20-minute part is unviewed. Here, the moving image thumbnail is generated and displayed such that the 10-minute video image viewed from the beginning is reproduced by the rough digest and the remaining 20-minute video image is reproduced by the dense fine digest. Alternatively, the moving image thumbnail is generated and displayed such that the 10-minute video image viewed from the beginning is reproduced at the low frame rate and the remaining 20-minute video image is reproduced at the high frame rate. The display size and other conversion processes are also similarly applicable. Furthermore, it is also possible that the moving image thumbnail is generated and displayed such that the number of viewing times of each part of the video image is counted and according to the number of viewing times, the above-described display size conversion, frame rate conversion, digest conversion are applied to each part of the video image.

### Third Embodiment

The present embodiment is about a display apparatus that holds information indicating an elapsed time from the previous time viewing, and that selects the moving image/still image based on the information or selects the frame rate of the moving image thumbnail and the like.

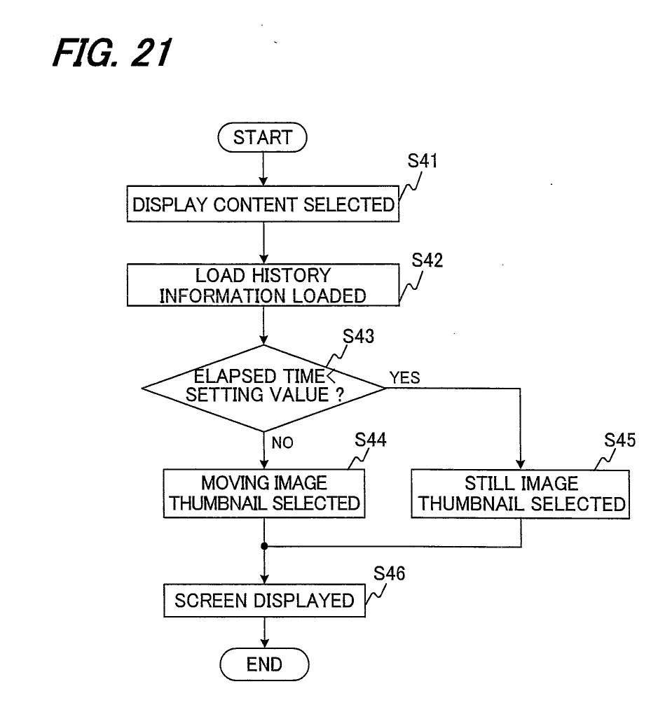

FIG. 21 is a flowchart of processing procedures for determining a moving image/still image thumbnail display based on the elapsed time from the previous time viewing. The display apparatus 20 shown in FIG. 3 is used in this case.

When the thumbnail display control unit 21 displays a thumbnail on the display unit 23 by receiving the thumbnail data, the thumbnail display control unit 21 selects a video image (content) to be displayed by the thumbnail and sends the information to the determination unit 25 (step S41). The determination unit 25 loads viewing history information corresponding to the selected content from the holding unit 24 (step S42). The viewing history information to be loaded is the viewing history information 35 of FIG. 8.

At a step S43, the determination unit 25 determines based on the history information whether the elapsed time from the last viewing of the viewed video image is shorter than a set value (time) given in advance. When the elapsed time is shorter than the set value because sufficient time has not elapsed from the last viewing (step S43; Yes), the still image thumbnail is selected (step S45). When the elapsed time is equivalent to or more than the set value because sufficient time elapses from the last viewing (step S4; No), the moving image thumbnail is selected (step S44). As described in the first embodiment, the unviewed video image is determined as the case of the elapsed time equivalent to or more than the set value.

For example, the elapsed time from the last viewing of the viewed video images B, C and D is calculated based on a difference between the last viewing time held in the viewing history information 35 and the current time. The elapsed time of the video image B is; “07/03/26/17/00”−“07/03/23/20/00”=“00/00/02/21/00” (2 days and 21 hours). Similarly, the elapsed time of the video image C is; “07/03/26/17/00”−“06/11/23/21/00”=“00/04/02/20/00” (4 months, 2 days and 20 hours), and the elapsed time of the video image D is “07/03/26/17/00”−“07/03/23/21/00”=“00/00/02/20/00” (2 days and 20 hours). The video image A is unviewed, that is, it is determined that the elapsed time is the maximum.

Even the video image had been viewed, for the one that sufficient time has elapsed from a last viewing, a user's memory is considered to be fading. Here, the set value is set to seven days. As a result, the determination unit 25 decides to display the unviewed video image A and the video image C by the moving image thumbnail and decides to display other video images B and D by the still image thumbnail.

In the case of a step S44, the selection unit 26 selects the moving image thumbnail data to send to the thumbnail display control unit 21. In the case of a step S45, the selection unit 26 selects the still image thumbnail data to send to the thumbnail display control unit 21. The thumbnail display control unit 21 reproduces the input moving image thumbnail data and still image thumbnail data, which are arranged and displayed (step S46). FIG. 10 shows a display example of the screen where the video images A, B, C, and D are displayed by the thumbnails. The video images A and C are the moving image thumbnails and the video images B and D are the still images thumbnails.

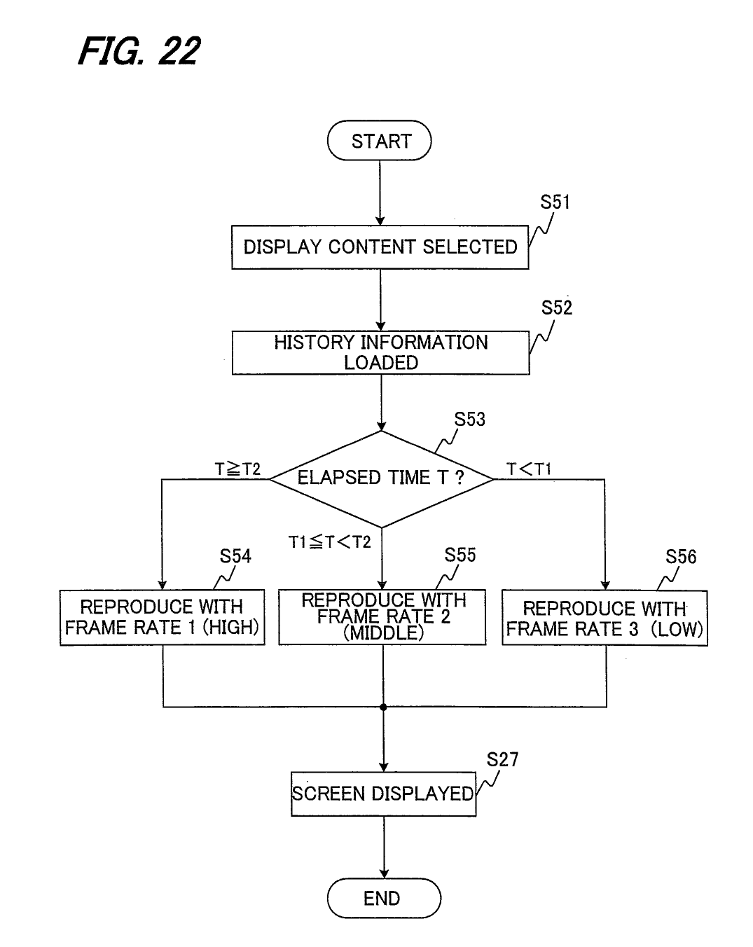

FIG. 22 is a flowchart of processing procedures for shifting a frame rate of the thumbnail step by step based on the elapsed time. The display apparatus 60 shown in FIG. 18 is used in this case.

When the thumbnail display control unit 61 displays a thumbnail on the display unit 23 by receiving the thumbnail data, the thumbnail display control unit 61 selects a video image (content) to be displayed by the thumbnail and sends the information to the determination unit 65 (step S51). The determination unit 65 loads viewing history information corresponding to the selected content from the holding unit 24 (step S52). The viewing history information to be loaded is the viewing history information 35 of FIG. 8.

The determination unit 65 compares the elapsed time T with the set values T1 and T2 (T1<T2) based on the obtained history information, and decides which is greater or smaller (step S53). When the elapsed time T is equal to or more than the set value T2 (T1≧T2), the user has not yet viewed the video image or has a fading memory because longtime has elapsed from viewing. Accordingly, the moving image thumbnail with the high frame rate is selected (step S54). When the elapsed time T is equal to or more than the set value T1 and less than the set value T2 (T1≦T<T2), the moving image thumbnail with the middle frame rate is selected (step S55). When the elapsed time T is less than the set value T1 (T<T1), since little time has elapsed from the last viewing and the viewed video image is sufficiently in the memory, the moving image thumbnail with the low frame rate is selected (step S56).

The thumbnail display control unit 61 reproduces the input moving image thumbnail data at a frame rate specified by the determination unit 65, which is arranged and displayed on the screen of the display unit 23 (step S57). When T1 is one day and T2 is one month, for example, in the viewing history information 35 of FIG. 8, the video image A is the high frame rate, the video images B and D are the middle frame rate and the video image C is the low frame rate.

In the flowchart above, the frame rate has been described, but the display size or the roughness of the digest may be shifted step by step. For example, the maximum display size or the fine digest is provided at the step S54, the middle display size or the middle digest at the step S55, and the minimum display size or the rough digest at the step S56.

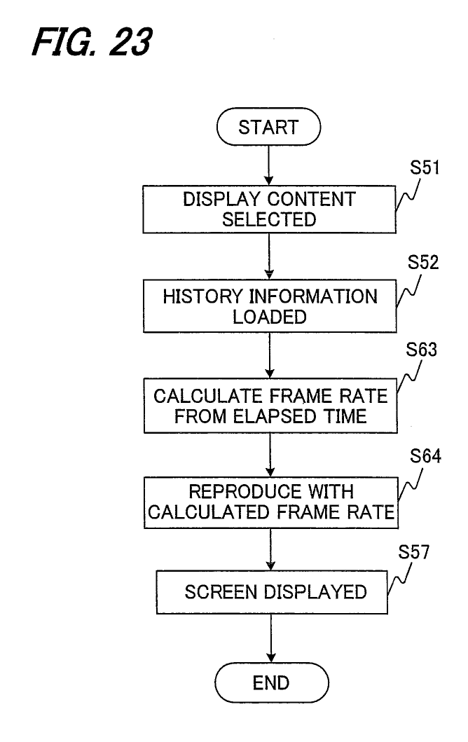

FIG. 23 is a flowchart of processing procedures for continuously shifting the frame rate. The display apparatus 60 shown in FIG. 18 is used in this case.

When the thumbnail display control unit 61 displays a thumbnail on the display unit 23 by receiving the thumbnail data, the thumbnail display control unit 61 selects a video image (content) to be displayed by the thumbnail and sends the information to the determination unit 65 (step S61). The determination unit 65 loads viewing history information corresponding to the selected content from the holding unit 24 (step S62). The viewing history information to be loaded is the viewing history information 35 of FIG. 8.

At a step S63, the determination unit 65 calculates a frame rate based on the elapsed time. A calculation formula at this time is given in advance and calculation is performed using this calculation formula. For example, in view of the elapsed time T [month] (quantization is applied such that the elapsed time of less than one month is T=1, and the one of (t−1) months or more and less than t months is T=t) and the frame rate r [frame/second], the calculation formula f(T) is defined as;

r=f(T)=T (in the case of T<30) 30 (in the case of T≧30)

1 [frame/second] is provided when the elapsed time is less than one month, 15 [frame/second] is provided when the elapsed time is 14 months or more and less than 15 months. 30 [frame/second] is provided when the elapsed time is 30 months or more (including unviewed).

Naturally, the calculation formula for calculating the frame rate is not limited to the above example. Alternatively, a data table capable of obtaining the frame rate based on the elapsed time may be provided to obtain. when the elapsed time from the last viewing is shorter, it is determined that the memory is retained well. Accordingly, the frame rate is lowered by the defined calculation formula as the elapsed time is shorter. Then, when the video image is unviewed, the frame rate is set to the maximum. Then, the frame rate is increased as exceeding a predetermined time.

The thumbnail display control unit 61 reproduces the input moving image thumbnail data at a frame rate set by the determination unit 65 (step S64), which is displayed on the screen of the display unit 23 (step S57).

Note that, the frame rate has been described in the flowchart above, but the display size or the roughness of summary by the digest may be shifted continuously. That is, when the elapsed time from the last viewing is within the predetermined time, the display size is reduced. when the video image is unviewed, the display size is set to the maximum. The display size is increased as exceeding the predetermined time. Furthermore, when the elapsed time from the last viewing is within the predetermined time, the digest is set to be rough. When the video image is unviewed, the roughness is set to the minimum. The roughness is lowered as exceeding the predetermined time.

In this way, when the elapsed time from the last viewing is within the predetermined time, the user's memory is retained, so that the amount of information of the thumbnail display form is reduced. As the predetermined time is exceeded, the user's memory becomes vague, so the amount of information of the thumbnail display form is increased. When the thumbnail is displayed, the thumbnail having an appropriate amount of information is displayed for each video image, which enables the user to search the video image more comfortably.

### Fourth Embodiment

In the fourth embodiment, when viewing is finished, a thumbnail display format the time of next list display [still image (specified frame)/moving image, roughness of the moving image] is selected, and the information is held to control the thumbnail display form at the time of next list display by the information. In the description, the display apparatus 20 shown in the block diagram of FIG. 3 is used.

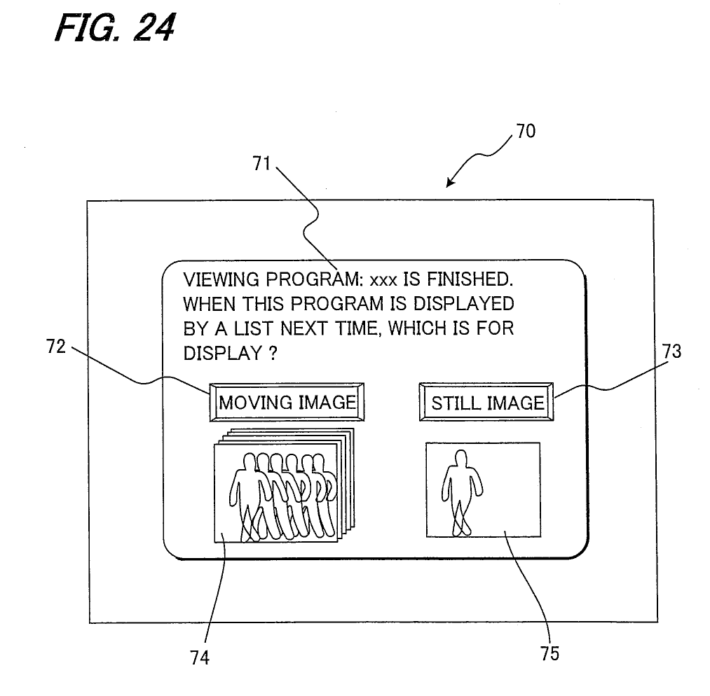

FIG. 24 is an example of a selection screen which is displayed after finishing viewing.

A screen 70 displays a description 71, “VIEWING PROGRAM: xxx IS FINISHED. WHEN THIS PROGRAM IS DISPLAYED BY A LIST NEXT TIME, WHICH IS FOR DISPLAY?”, a moving image thumbnail switch 72, a still image thumbnail switch 73, a moving image thumbnail 74 arranged under the moving image thumbnail switch 72 and a still image thumbnail 75 arranged under the still image thumbnail switch 73.

The user reads the description 71, selects the thumbnail desired to be displayed at the time of next list display, and clicks either the moving image thumbnail switch 72 or the still image thumbnail switch 73. The moving image thumbnail 74 and the still image thumbnail 75 are displayed to make the user easily understand what the thumbnail is like so as to avoid wrong depression of the switch.

When the display apparatus 20 of FIG. 3 is used, the thumbnail display control unit 21 holds instruction information on the thumbnail display form of the next display by the user's operation in the holding unit 24. At the time of next display, the determination unit 25 reads out the instruction information on the thumbnail display form from the holding unit 24, and sends the instruction to the selection unit 26. The selection unit 26 selects the still image/moving image thumbnail according to the instruction information, and the thumbnail display control unit 21 causes the display unit 23 to display the selected thumbnail.

Note that, the display form is not limited to the still image/moving image thumbnail, but may be the frame rate, the display size or the digest (roughness) in the moving image thumbnail.

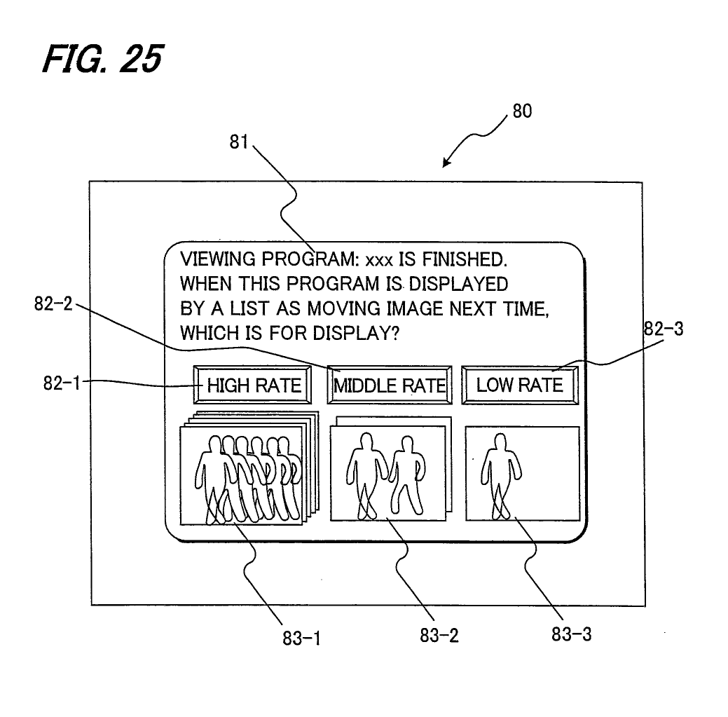

FIG. 25 is an example of a selection screen showing options of moving image thumbnail displayed after finishing viewing. Furthermore, a selection screen 80 of FIG. 25 may be a selection screen displayed after the moving image thumbnail is selected (the moving image thumbnail switch 72 is depressed) on the selection screen 70 of FIG. 24.

The user reads a description 81 on the screen 80, selects the moving image thumbnail (rate) desired to be displayed at the time of next list display, and clicks any of the switches 82-1 through 82-3. The moving image thumbnails 83-1 through 83-3 are displayed to make what the thumbnail is like easily understandable so as to be easily selected by the user.

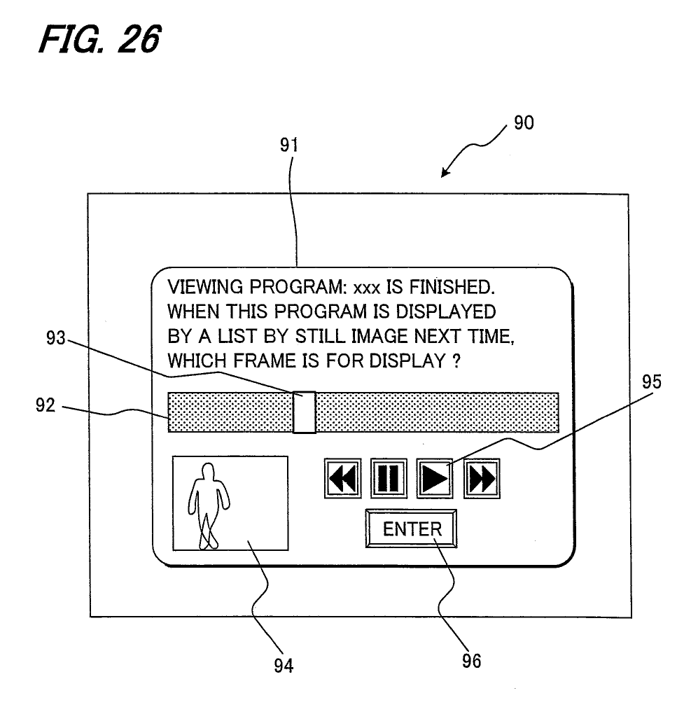

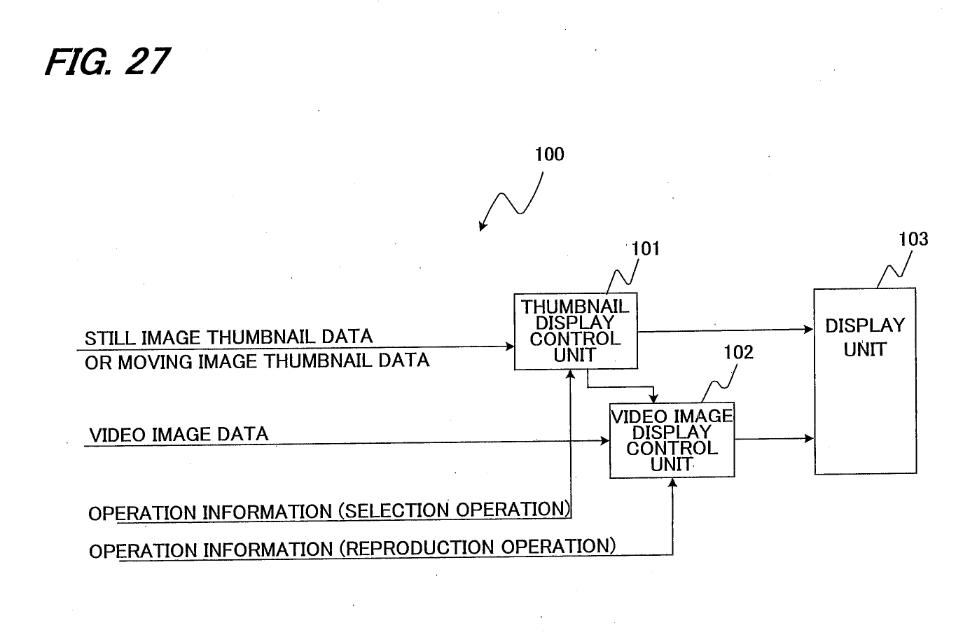

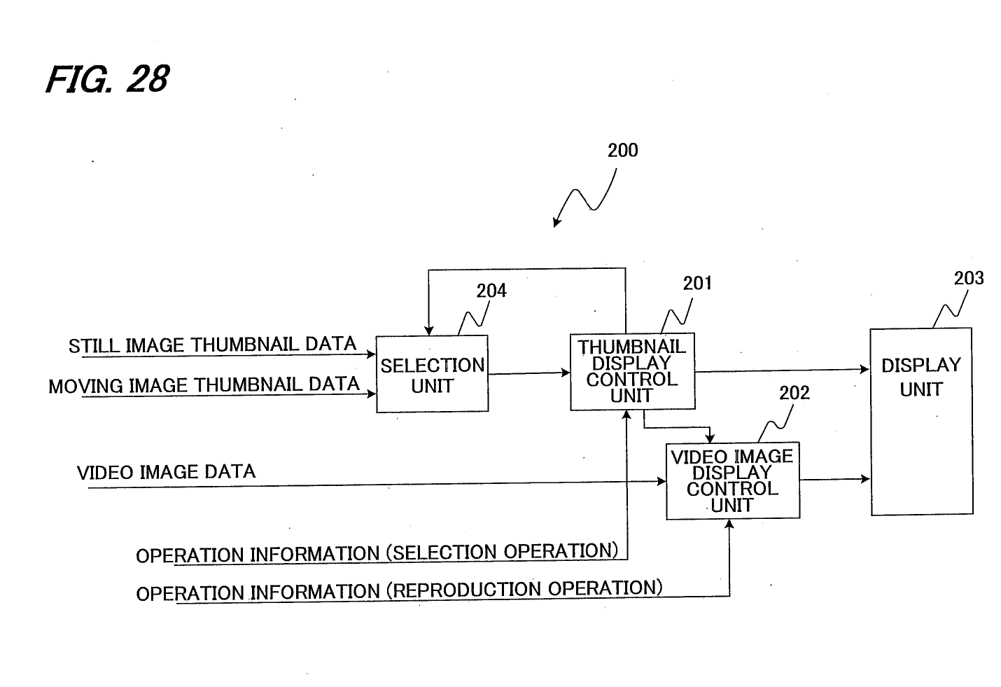

FIG. 26 is an example of a selection screen for selecting a frame for displaying the still image thumbnail, which is displayed after the still image thumbnail is selected (the still image thumbnail switch 73 is depressed) on the selection screen 70 of FIG. 24.

The user reads a description 91 on a screen 90 and selects the still image thumbnail (frame) desired to be displayed at the time of next list display. Displayed on the screen 90 are, a bar 92 for representing the whole video image, a cursor 93 for representing a current position, a still image thumbnail 94 for displaying a frame corresponding to the current position by the thumbnail, operation switches 95, and an enter switch 96. The user operates the operation switches 95, confirms the current position and a frame image at the position using the cursor 93 and the thumbnail 94 and depresses the enter switch 96 while displaying a desired frame on the thumbnail 94 to select the still image thumbnail to be displayed at the time of next list display.

In this way, the user is able to select the appropriate thumbnail display form on his or her own, which enables further comfortable searching of the video image.

Naturally, the selection screens 70, 80 and 90 shown in FIGS. 24 through 26 are given as the examples and various selection screens or selection methods may be adopted actually. In the fourth embodiment of the present invention, it is characteristic that, when any of the selection screens and selection methods is adopted, the thumbnail display form at the time of next list display is selected after finishing viewing and the information is held to control the thumbnail display form at the time of next list display.

As described above, in each embodiment of the present invention, the information amount of the video image to be displayed by the thumbnail is increased as the user's memory of the video image is more uncertain, with the one unviewed being set to the maximum, the information amount to be displayed by the thumbnail is reduced as the user's memory is more certain, and a degree of certainty of the user's memory is estimated from the number of viewing times of the video image, the elapsed time from the last viewing and the like. The description hereinafter will be given, as a special case, for a case where the user regards the video image repeatedly viewed as a video image of which the user's memory is uncertain and the thumbnail with great amount of information is displayed.

When there is a video image that is repeatedly viewed by the user, for example, a video image that is determined from the number of viewing times and the history of viewing time as having been viewed many times in a short period, it is considered that the user has viewed the video image many times for confirmation. That is, it is possible to regard the user's memory of the video image as uncertain. In addition, the video image that has been viewed many times in the short period is a particularly important video image to the user and the user tries to obtain more information on the video image by viewing the video image. That is, it is possible to regard the memory of the video image that the user has obtained so far as being in insufficient condition. In this manner, since the user's memory of the video image that has been repeatedly viewed by the user in the short period is in uncertain or insufficient condition, in the present invention, the information amount of the video image to be displayed by the thumbnail is increased. The moving image display is performed at the high frame rate, for example.

Such a processing is able to be implemented by adding to the determination units 25 and 65 and the thumbnail display control units 21 and 61 in the display apparatuses 20 and 60 in each embodiment described above. That is, the determination units 25 and 65 determine from the history information held in the holding unit 24 whether or not a target video image has been repeatedly viewed in the short period, select and specify the thumbnail display form. Then, the thumbnail display control units 21 and 61 reproduce the thumbnail according to the specified display form to display in the display unit 23. That is, the characteristics of the display apparatus and display method of the present invention are that the thumbnail display form is controlled to be changed based on whether the user's memory of the video image is certain or not, and the way how to estimate from the number of viewing times or the elapsed time from the last viewing whether the user's memory of the video image is certain or not is not limited. As described above, various methods for estimating are able to be defined and used.

In the above description of each embodiment of the present invention, the video image displayed by the list on the screen is described as the thumbnail-form video image, but is not limited thereto. The display apparatus and display method of the present invention are widely applicable to any of a video image display system having a function to arrange and display a plurality of video images on a single screen, that is, a multi-display system of video images. It is characteristic of the display apparatus and display method of the present invention that the display of each video image for a multi-display on the single screen is controlled based on the viewing history of each video image.

Note that, the disclosed embodiments should be considered to be given as examples and not limited on every point. The scope of the present invention is shown not by the above description, but by the scope of the claims, and any modification in the meaning and within the scope equivalent to the scope of the claims is intended to be included.

1-12. (canceled)

13. A display apparatus capable of displaying a list of a plurality of video images, accumulated or transmitted, in a display form which is directly obtained from the vide image, comprising:
holding means for holding viewing history information of the video image;
determination means for setting the display form of which an information amount is reduced, for the video image that is able to be determined as a viewer's memory is more certain, based on the viewing history information; and
display controlling means for controlling the display form of the video image at the time of list display based on the setting by the determination means, wherein
the viewing history information includes information showing an elapsed time from a last viewing, and
the determination means sets the display form of which an information amount is reduced when the elapsed time as the viewing history information is shorter than a predetermined time, and sets the display form of which an information amount is increased when the elapsed time as the viewing history information is equivalent to or more than the predetermined time.

14. The display apparatus as defined in claim 13, wherein the viewing history information further includes information showing the number of viewing times, and the determination means, in the case where the number of viewing times as the viewing history information is smaller than a predetermined value, sets the display form of which an information amount is reduced when the elapsed time as the viewing history information is smaller than a first set value and sets the display form of which an information amount is increased when the elapsed time as the viewing history information is equivalent to or more than the first set value, and, in the case where the number of viewing times as the viewing history information is equivalent to or more than the predetermined value, performs the determination processing based on the predetermined time as a second set value.

15. The display apparatus as defined in claim 13, wherein the determination means sets a frame rate at the time of moving image display.

16. The display apparatus as defined in claim 13, wherein the determination means sets a digest reproduction of the video image at the time of moving image display.

17. The display apparatus as defined in claim 13, wherein the determination means sets a display size at the time of moving image display.

18. The display apparatus as defined in claim 15, wherein the determination means sets an information amount of the video image to be displayed by the moving image to be reduced as the elapsed time is shorter, to be maximum when unviewed, and sets an information amount of the video image to be displayed by the moving image to be increased as the elapsed time is greater.

19. The display apparatus as defined in claim 13, wherein the holding means holds setting information after a viewer sets a display form at the time of displaying a list of the video image next time, and the determination means sets the display form by obtaining the setting information from the holding means when displaying the video image by a list next time.

20. A display method capable of displaying a list of a plurality of video images, accumulated or transmitted, in a display form which is directly obtained from the video image, comprising the steps of:
reading out viewing history information of the video image that has been held in holding means;
setting the display form of which an information amount is reduced for the video image that is able to be determined as remaining in a viewer's memory based on the viewing history information read out by a determination means; and
controlling the display form of the video image at the time of list display based on the setting,
wherein the viewing history information includes information showing an elapsed time from a last viewing, and
wherein the determination means carries out that, the display form of which an information amount is reduced is set when the elapsed time as the viewing history information is shorter than a predetermined time, and the display form of which an information amount is increased is set when the elapsed time as the viewing history information is equivalent to or more than the predetermined time.
